(19) United States
(12) Patent Application Publication
(10) Pub. No.: US 2008/0127168 A1
(43) Pub. Date: May 29, 2008

(54) Setup of workloads across nodes

(75) Inventors: Edward K. Tremblay, Bellevue, WA (US); Bjorn B. Levidow, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/506,513

(22) Filed: Aug. 18, 2006

(51) Int. Cl. G06F 9/445

(52) U.S. Cl. 717/174

(57) ABSTRACT

Aspects of the subject matter described herein relate to setting up nodes. In aspects, a setup process is started to install software components to provide services to other nodes. The setup process asks for a product key and maps the product key to a product definition that indicates a number of nodes upon which the software is allowed to be installed. The product definition may also indicate what services are allowed to be installed by the setup process. The user indicates the number of nodes on which he wishes to install the software. The user may then indicate which nodes the user wishes to provide which services. This setup data is stored and may be used to determine what services to install when the setup process is executed on each of the nodes.

### BACKGROUND

In small organizations, often a single server is all that is needed to serve the needs of the organization. In such cases, installing software on the server is a matter of inserting media into the server and performing a setup.

A larger organization, however, may have several servers to meet the needs of the organization. A large company may also have many specialized personnel dedicated to setting up and maintaining the computer resources controlled by the company. For example, one person may be in charge of setting up e-mail accounts, another person may be in charge of configuring routers, another person may be in charge of installing an application, and so forth.

Small and mid-size companies do not typically have such a team of specialists. Often one individual may be in charge of all the computer needs of the organization. Because the individual may not be aware of how servers may need to be configured, particularly in a multi-server setup, sub-optimal or incorrect configuration may occur.

### SUMMARY

Briefly, aspects of the subject matter described herein relate to setting up nodes. In aspects, a setup process is started to install software components to provide services to other nodes. The setup process asks for a product key and maps the product key to a product definition that indicates a number of nodes upon which the software is allowed to be installed. The product definition may also indicate what services are allowed to be installed by the setup process. The user indicates the number of nodes on which he wishes to install the software. The user may then indicate which nodes the user wishes to provide which services. This setup data is stored and may be used to determine what services to install when the setup process is executed on each of the nodes.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements an in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that includes some exemplary components of a setup component in accordance with aspects of the subject matter described herein;

FIG. 4 is a flow diagram that generally represents exemplary actions that may occur during a setup process in accordance with aspects of the subject matter described herein;

FIG. 5 is a flow diagram that generally represents actions that may occur to provide setup data to another node executing the setup process in accordance with aspects of the subject matter described herein; and

FIG. 6 is a flow diagram that generally represents actions that may occur to obtain setup data from another location during setup in accordance with aspects of the subject matter described herein.

### DETAILED DESCRIPTION

### Exemplary Operating Environment

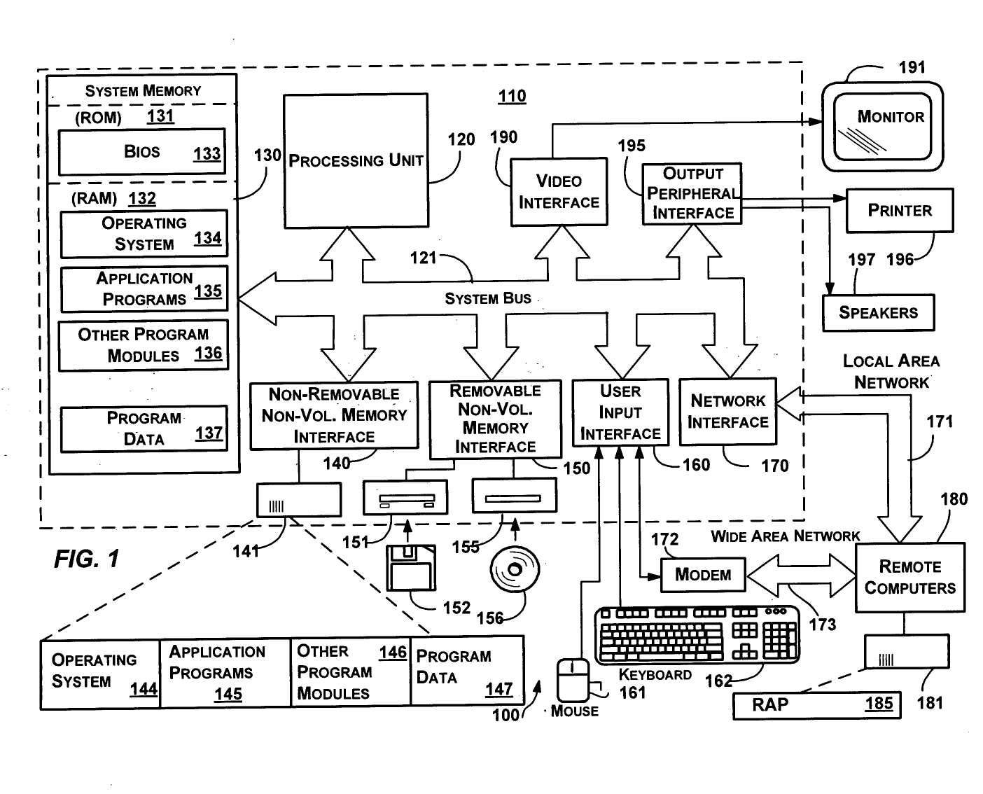

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as, a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Setup of Workloads

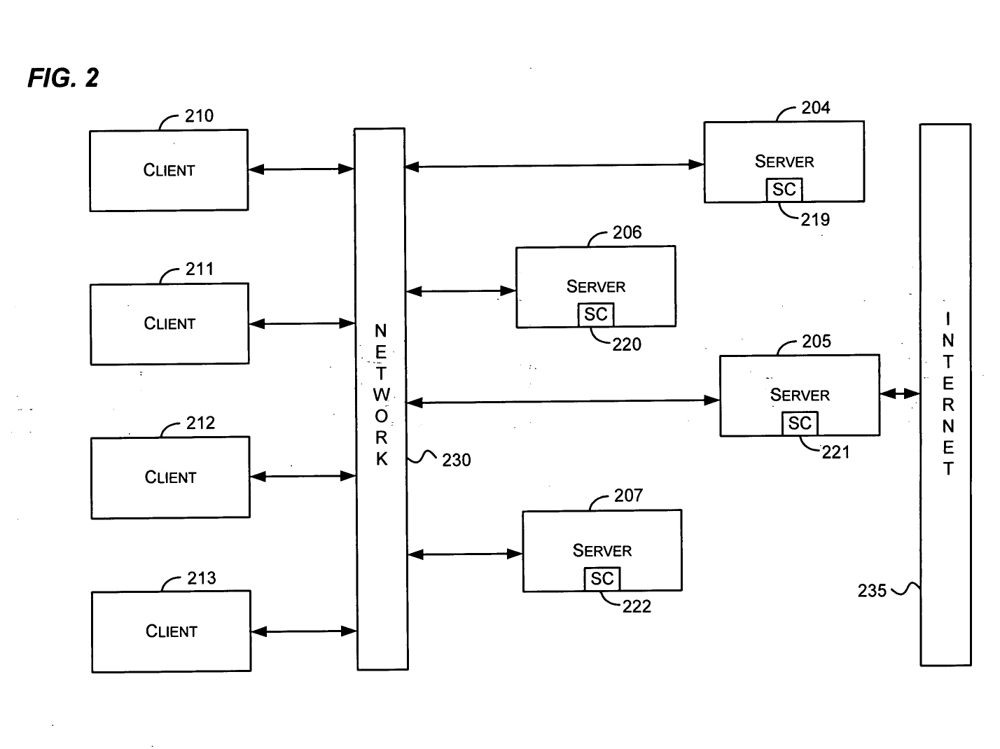

FIG. 2 is a block diagram representing an exemplary environment in which aspects of the subject matter described herein may be implemented. In one embodiment, the environment includes servers 204-207 and clients 210-213 and other components (not shown). The servers 204-207 may also include setup components 219-222, respectively, to assist in installing services on the servers 204-207.

In other embodiments, the number of servers and clients and the arrangement thereof may be changed without departing from the spirit or scope of aspects of the subject matter described herein. Clients and servers may communicate with each other and with other entities (e.g., routers, firewalls, and other entities not shown) via various networks including intra-office network 230 and the Internet 235.

Each of the servers 204-207 and the clients 210-213 may be implemented on one or more computers (e.g., computer 110 as described in conjunction with FIG. 1). In a modern office, there may be a need for the servers 204-207 to provide many types of services (also sometimes called “workloads”). One exemplary service is monitoring nodes (e.g., clients 210-213 and servers 204-207) to determine whether the nodes are operating correctly, up-to-date with respect to software versions and anti-virus signatures, and the like. A service that is monitoring nodes may display or send a message to a console for viewing by a system administrator or the like (hereinafter collectively referred to as a “system administrator” or “user,”).

Another exemplary service includes hosting a document repository in which documents, files, versions thereof, and the like may be stored. One exemplary document repository is SharePoint® produced by Microsoft Corporation of Redmond, Wash. although other document repositories may also be hosted without departing from the spirit or scope of aspects of the subject matter described herein.

Another exemplary service is a directory service that stores and organizes information about a network's users, shares, and resources. The directory service may allow network administrators to control access to resources available through the network. Exemplary directory services include Network Information Service (NIS), eDirectory, Red Hat directory server, Active Directory, Open Directory, Apache Directory Server, and Oracle Internet Directory to name a few.

Another exemplary service is a Dynamic Host Configuration Protocol (DHCP) process that supplies each other local node with an IP address at which the node is accessible, a subnet mask, a default gateway, an IP address for a Windows Internet Name Service (WINS) server, and an IP address for a Domain Name System (DNS) server. An organization may also wish to have a WINS and DNS server under its control to provide services to other nodes.

It may also be beneficial to have a service that replicates the directory service (and associated data) in case a master directory service becomes non-operational or corrupt. Other services that may be needed by an organization include an e-mail server, calendaring software, a message store, an anti-virus engine that examines e-mails, and the like.

Other exemplary services include providing access to resources and entities available on the Internet 235, firewall capability, spam filtering, authentication of remote users attempting to access resources connected to the network 230, anti-virus monitoring, port filtering, port forwarding, and the like.

The list of services and servers indicated above are not intended to be exhaustive list of all the services and servers that may be needed or desired by an organization. Indeed, those of ordinary skill in the art will recognize that there are many other services and servers that an organization may need or desire to be more productive, efficient, or organized. In embodiments, systems including such services and/or servers are also included within the spirit and scope of aspects of the subject matter described herein.

As used herein, each of the terms “server” and “client” may refer to one or more physical entities, one or more processes executing on one or more physical entities, and the like. Thus, a server may include an actual physical node upon which one or more processes execute, a service executing on one or more physical nodes, or a group of nodes that together provide a service. A service may include one or more processes executing on one or more physical entities.

The number of servers an organization desires may be determined by the organization's size, activities, budget, and the like. Determining which services to place on which servers to provide an optimum system and then actually installing the services may be beyond the skill set of an information technology (IT) professional tasked with providing all the IT needs of an organization.

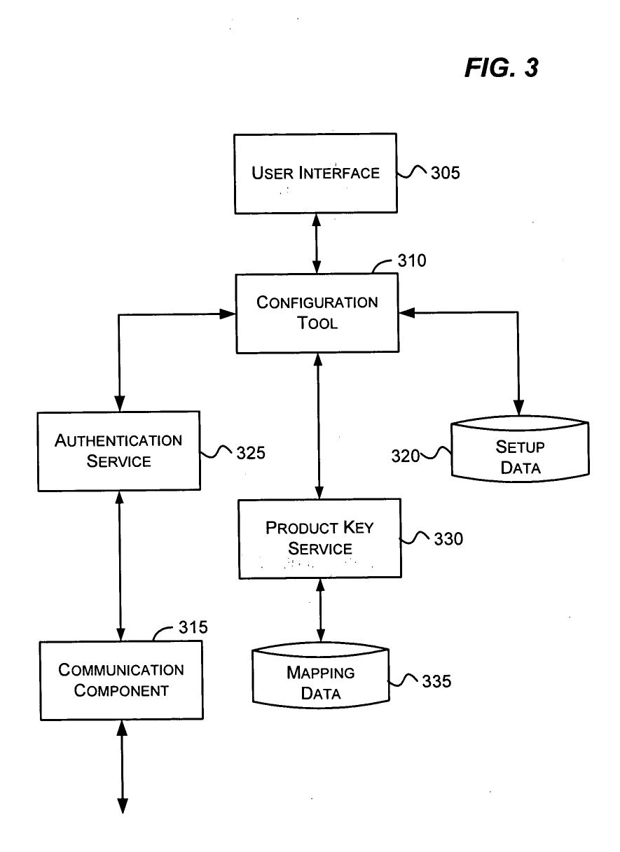

FIG. 3 is a block diagram that includes some exemplary components of a setup component in accordance with aspects of the subject matter described herein. The components may include a user interface 305, a configuration tool 310, a communication component 315, setup data 320, an authentication service 325, a product key service 330, and mapping data 335. Examples of the communication component 315 include the modem 172 and network interface 170 of FIG. 1.

In operation, the configuration tool 310 may interact with a system administrator via the user interface 305. Through the user interface 305, the configuration tool 310 may display the setup state of each server that is to provide services to a set of nodes. The set of servers that are to provide services to a set of nodes is sometimes referred to as a configuration set.

Starting with a first node, the system administrator may execute a setup process on each node of a configuration set (e.g., servers 204-207 of FIG. 2). In one embodiment, the setup process may be executed by logging on to a node, inserting media, accessing a shared network drive from the node, or otherwise accessing storage media and accessing a setup program, and executing the setup program on each of the nodes.

The first node upon which the setup process executes (sometimes referred to as the “master node”) may gather information regarding the setup of services for the configuration set. For example, the configuration tool 310 may prompt the system administrator for a product key. The product key may map to a product definition that may indicate the maximum number and types of servers that may be utilized and the services that may be installed under licensing agreements associated with the product. For example, the product key may map to a product definition that indicates that certain services may be installed on no more than five servers with each server having four or fewer CPUs.

The configuration tool 310 may provide an entered product key to the product key service 330 to determine what services may be installed on what servers. The product key service 330 may use the mapping data 335 to map the product key to a product definition. The product key service 330 may then obtain the characteristics of the product (e.g., number of servers, type of servers, types of services, and the like). After determining what services may be installed, the configuration tool 310 may provide a menu to the system administrator through the user interface 305. The menu may indicate what the product key allows and may ask the system administrator to indicate how many servers the system administrator wishes to use to provide the allowed services.

After obtaining a valid product key, the configuration tool 310 may request that the system administrator provide server names and assign services to each of the servers. In one embodiment, the configuration tool 310 may indicate default or preferred assignments of services to servers based on the number of servers selected, the characteristics of the servers, and the services allowed by the product key. The system administrator may modify the assignment as desired or may clear all assignments and come up with a custom assignment of services to servers.

After the system administrator has entered the server names and assignment of services to servers, the configuration tool 310 may store this information in the setup data 320. The data that indicates the assignment of services to servers is sometimes referred to as “assignment data.” In one embodiment, the setup data 320 is stored on or accessible through the master node. In another embodiment, the setup data 320 may be replicated and available from various nodes within the configuration set. In yet another embodiment, the setup data may be stored in a central database accessible from any node connected to the network (provided the node supplies the proper credentials). After the system administrator has finished the setup process for the master node, the system administrator may go to another node and start the setup process.

After a node is setup enough to know where the master node of its configuration set is located (e.g., a through discovery protocol and/or explicit user instruction), the node may obtain configuration data from the master node. Such configuration data may include, for example, the addresses of servers (e.g., DNS servers, e-mail servers, directory service server, and the like) and which services are to be installed on the node. The node may communicate with the master node via the communication component 315. The authentication service 325 may check the credentials of the node before granting access to the setup data 320. After the node has access to the setup data 320, the node may use this data to determine what services the node may install. The node may also use the data to know where the node may request other services (e.g., directory service, WINS, DNS, etc.) provided by the configuration set and other nodes.

In another embodiment, a service, process, or the like (e.g., a setup component) executes on each node that is to be setup to provide services. A system administrator may log into any node and, via the service, may setup each node of a configuration set without logging on to each node from the node's console.

In one embodiment, the setup component may allow a system administrator to migrate services from one server to another server after initial setup has completed. The system administrator may log onto the master node, indicate a different assignment of services to servers, log onto a server upon which to install services, and have the new server download configuration data and install the services. As part of the migration, the server from which the services were migrated may cease providing the services by disabling or uninstalling them.

In another embodiment, the setup component may also be included on client nodes to assist in configuring the client nodes as to where they may access services provided by the configuration set.

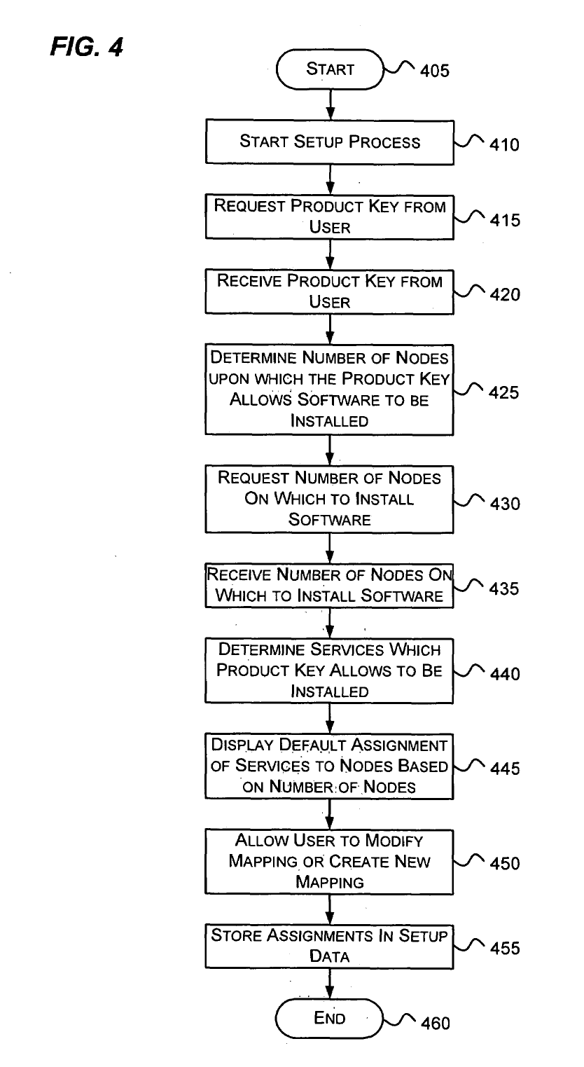

FIG. 4 is a flow diagram that generally represents exemplary actions that may occur during a setup process in accordance with aspects of the subject matter described herein. At block 405, the actions begin.

At block 410, a setup process is started. For example, referring to FIG. 2, a setup process may be started by inserting a DVD into the server 206 and executing a setup program contained on the DVD.

At block 415, a product key is requested from the user performing the setup. For example, referring to FIG. 3, the configuration tool 310 may request a product key from the user via the user interface 305. At block 420, the product key is received by the configuration tool.

At block 425, the number of nodes upon which the product key allows software to be installed is determined. This may be done as described previously, for example, by consulting mapping data that maps product keys to product definitions. For example, referring to FIG. 3, the configuration tool 310 may determine the maximum number of nodes a product key allows by presenting the product key to the product key service 330 which consults the mapping data 335 to determine a product definition. The product definition may then be used to obtain the maximum number of nodes the product key allows.

At block 430, the number of nodes upon which to install software is requested from the user. For example, referring to FIG. 3, the configuration tool 310 may request this number from the user via the user interface 305. At block 435, this number is received.

At block 440, the services which the product key allows to be installed are determined. This may be done by consulting the product definition which, in addition to having the maximum number of nodes upon which the software may be installed, may also have a listing of the services allowed by the product key.

At block 445, a default assignment of services to nodes based on the number of nodes and available services is presented to the user. This default assignment may be stored in a product definition or elsewhere without departing from the spirit or scope of aspects of the subject matter described herein. For example, referring to FIG. 3, the configuration tool 310 may display a table including default assignments of services to nodes.

In one embodiment, the number of nodes upon which to install software is completely determined by the product key. In other words, the product key may indicate the number of nodes upon which to install the software. In this embodiment, the configuration tool 310 may not request a number of nodes from the user. Instead, the configuration tool 310 may obtain this number using the product key. In this embodiment, the actions associated with blocks 430 and 445 may be skipped.

At block 450, the user may modify this assignment or may clear all assignments and come up with an entirely different assignment.

At block 455, the assignment data is stored in setup data so that other servers that are setup as part of the setup process may access the setup data to determine what services they are to install.

At block 460, the actions end. The setup process may continue on other nodes of the configuration set to install services on the other nodes as appropriate.

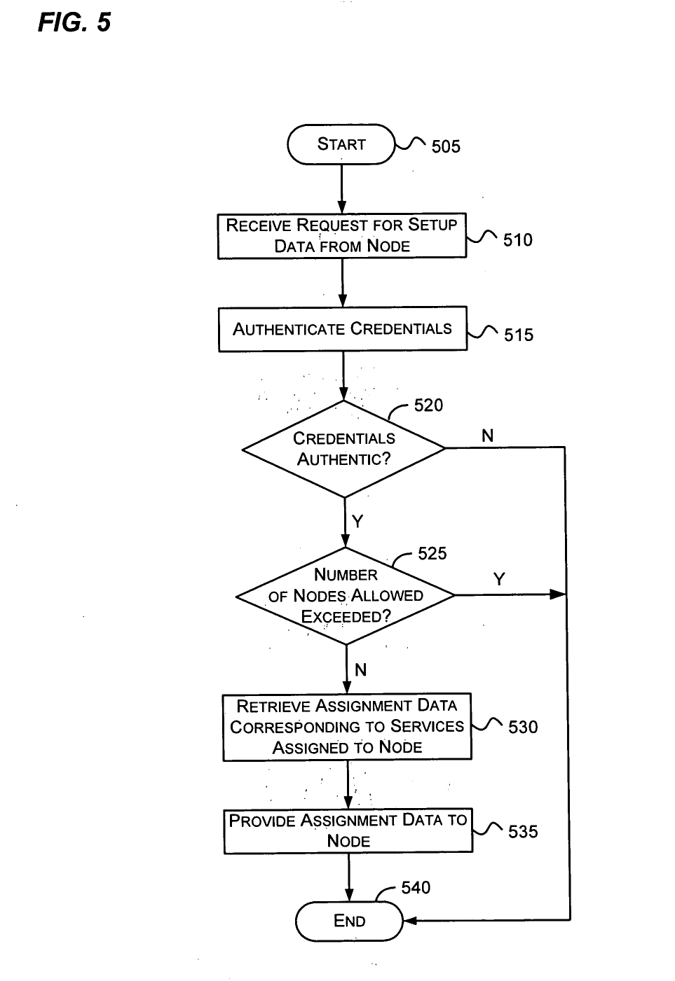

FIG. 5 is a flow diagram that generally represents actions that may occur to provide setup data to another node executing the setup process in accordance with aspects of the subject matter described herein. At block 505, the actions begin.

At block 510, a request for setup data is received from a node executing a setup process. The request may be received at a master node, a node replicating setup data, or a data store as previously indicated. For example, referring to FIG. 2, if the server 206 is the master node, the server 204 may request setup data from the server 206.

At block 515, credentials are authenticated. This may involve comparing the name of the node requesting the setup data to the server names indicated while performing setup on the master node. It may also involve checking a username and password of a user logged onto the node.

At block 520, if the credentials are authentic, the actions continue at block 525; otherwise, the actions continue at block 540.

At block 525, a determination is made as to whether the number of nodes allowed by the product key will be exceeded if the node is allowed to install services. If so, the actions continue at block 540; otherwise the actions continue at block 530.

At block 530, assignment data corresponding to services mapped to the node are retrieved from the setup data. As described previously, this data may indicate what services are to be installed on the node.

At block 535, the assignment data together with other setup data is provided to the node. At block 540, the actions end. The actions described above may be repeated each time a node executes the setup process to install software in a multi-node environment.

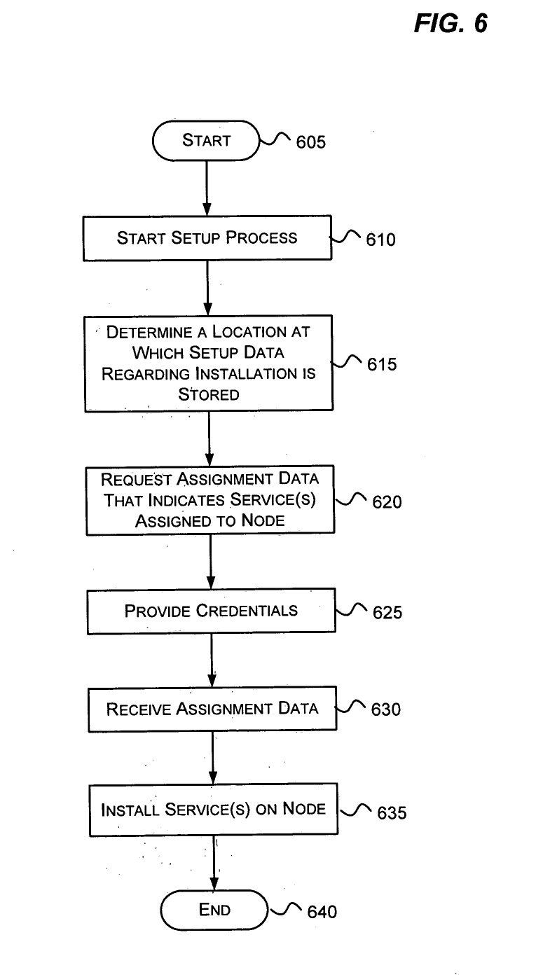

FIG. 6 is a flow diagram that generally represents actions that may occur to obtain setup data from another location during setup in accordance with aspects of the subject matter described herein. At block 605, the actions begin.

At block 610, the setup process on a node begins. In one embodiment, at least one other node of the configuration set of which the node is part executed a setup process previously and stored setup data. The node upon which the setup process is currently executing may locate this node or another node upon which the setup data is replicated to obtain the setup data as described in more detail below.

At block 615, a determination as to a location at which setup data regarding installation is stored is performed. As mentioned previously, this may be done through engaging in a discovery protocol and/or may involve asking a user to identify a location (e.g., server name, data store name, node name upon which data is replicated, and the like).

At block 620, the node requests assignment data that indicates service(s) the node is assigned to provide. At block 625, the node provides credentials to access the assignment data.

At block 630, the node receives the assignment data and may also receive other setup data as described previously. At block 635, the setup process installs service(s) based on the assignment data and configures itself to operate correctly (e.g., access services at specified locations) in view of the other setup data.

At block 640, the actions end. The actions described above may be repeated for each node of a configuration set that is setup.

In one embodiment, the actions described in conjunction with FIG. 4-6 are not all-inclusive of all the actions that may be taken in setting up nodes of a configuration set. Furthermore, although the actions are described in some embodiments as occurring in a particular order, in other embodiments, some of the actions may occur in parallel or may be performed in another order without departing from the spirit or scope of the subject matter described herein.

As can be seen from the foregoing detailed description, aspects have been described related to setting up services on nodes. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
executing a setup process as a part of installing software on a plurality of nodes that are to provide services;
receiving a product key;
determining a number of nodes on which the product key allows software associated with the setup process to be installed; and
limiting installation of the software to the number of nodes.

2. The computer-readable medium of claim 1, wherein executing a setup process as a part of installing software on a plurality of nodes that are to provide services comprises logging on to each node that is to provide services and executing a setup program on the node.

3. The computer-readable medium of claim 1, wherein determining a number of nodes on which the product key allows software associated with the setup process to be installed comprises mapping the product key to a product definition and obtaining the number of nodes from the product definition.

4. The computer-readable medium of claim 1, further comprising receiving a mapping that maps each service to a corresponding node and storing the mapping in setup data.

5. The computer-readable medium of claim 4, wherein limiting installation of the software to the number of nodes comprises authenticating credentials of a node requesting access to the setup data.

6. The computer-readable medium of claim 4, further comprising:
receiving a request for an indication of services mapped to a node;
retrieving data from the mapping corresponding to services mapped to the node; and
providing the data.

7. The computer-readable medium of claim 1, further comprising receiving an indication of a number of nodes upon which the software is to be installed and verifying that the number is less that the number of nodes on which the product key allows software associated with the setup process to be installed.

8. The computer-readable medium of claim 7, further comprising indicating a default mapping of services to nodes based on the indication of the number of nodes upon which the software is to be installed.

9. The computer-readable medium of claim 8, further comprising making a change to the default mapping of services to nodes based on user input.

10. The computer-readable medium of claim 1, wherein the services comprise any one or more of monitoring nodes, hosting a document repository, a directory service, a replica of the directory service, a dynamic host configuration protocol, an Internet name service, a domain name system, an e-mail service, a calendaring service, a message store, an antivirus engine, a service that provides access to the Internet, a firewall, a spam filter, an authenticating service, a port filtering service, and a port forwarding service.

11. The computer-readable medium of claim 1, further comprising determining the services based on the product key.

12. A method implemented at least in part by a computer, the method comprising:
executing, on a node, a setup process as part of an installation of software on a plurality of nodes;
determining a location at which setup data regarding the installation was previously stored;
requesting from the location assignment data that indicates a service assigned to the node; and
installing the service on the node.

13. The method of claim 12, wherein determining a location at which setup data regarding the installation was previously stored comprises engaging in a discovery protocol to search for the location.

14. The method of claim 12, wherein determining a location at which setup data regarding the installation was previously stored comprises receiving location information from a user.

15. The method of claim 12, wherein the location comprises any one or more of a node upon which a product key was entered, a node upon which the setup process was first executed, a node that replicates the setup data, and a database accessible over a network.

16. The method of claim 12, further comprising providing authentication credentials to gain access to the setup data.

17. In a computing environment, an apparatus, comprising:
a user interface component arranged to receive input from a user and provide output to the user;
a product key service arranged to map a product key to a product definition that indicates a number of nodes upon which a setup process is allowed to install services;
a setup data store arranged to store assignment data that associates each service with a node upon which to install the service; and
a configuration tool arranged to obtain the product key via the user interface component and to store the assignment data in setup data store

18. The apparatus of claim 17, further comprising an authentication component arranged to authenticate nodes that request access to the mappings to limit a number of nodes upon which the services are installed to the number of nodes indicated by the product definition.
